(19) United States
(12) Patent Application Publication
(10) Pub. No.: US 2006/0156078 A1
(43) Pub. Date: Jul. 13, 2006

(54) Method for restoring administrative data records of a memory that can be erased in blocks

(75) Inventors: Christoph Baumhof, Radolfzell-Guttingen (DE); Reinhard Kuhne, Reichenau (DE)

Correspondence Address: BROWDY AND NEIMARK, P.L.L.C.;624 NINTH STREET, NW, SUITE 300, WASHINGTON, DC, 20001-5303, US

(73) Assignee: HYPERSTONE AG, KONSTANZ (DE)

(21) Appl. No.: 10/518,636

(22) PCT Filed: Jun. 17, 2003
(86) PCT No.: PCT/EP03/06355

§ 371 Date: Sep. 13, 2005

(30) Foreign Application Priority Data
Jun. 19, 2002 (DE) 102 27 255.7

(51) Int. Cl. G06F 11/00

(52) U.S. Cl. 714/100

(57) ABSTRACT

The invention relates to a method for restoring administrative data records of a non-volatile memory that can be written in segments and erased in blocks, said records being stored in a more rapidly accessible internal volatile flag memory of an assigned memory controller. According to the invention, a reconstruction table (RKT), in which the extent of all write and erase operations is recorded as an entry, is continuously updated. This permits each administrative data record of the internal flag memory of the memory controller to be completely reconstructed during a restart after a power failure.

The invention describes a method for restoring the administrative data records of a nonvolatile memory that can be written to in units of sectors and erased in units of blocks, said records being stored in a volatile flag memory of an associated memory controller.

The widely used nonvolatile semiconductor memories (flash memories) are organized in blocks and in sectors, with a block consisting, e.g., of 32 sectors with 512 bytes each. The memories have the property that new information can be written in units of sectors and only previously erased sectors can be written to. The erasing takes place in each case for one block for all sectors together. Writing a sector to the memory takes longer than the reading and an erasure operation of a block requires a long time, e.g., several milliseconds.

According to a method for which patent protection is also being applied for at this time, tables in which administrative data records are recorded for the blocks and sectors in each case are maintained by a program in the associated memory controller in an immediate-access volatile flag memory. These tables essentially consist of assignments of logical block addresses to physical block addresses and the addresses of alternate blocks when sectors are written to the nonvolatile memory. If there now is a power failure, the data disappear from the volatile flag memory. They would thus have to be contained backed up in a portion of the nonvolatile memory at this time to be able to continue to operate with correct data after a restart. However, because of the duration of the write operations, there is no time left for this in case of a power failure. Constantly backing up all administrative data records with copies, however, would slow down all write operations and result in an increased wear on the nonvolatile memory.

Patent document U.S. Pat. No. 5,930,193 A also describes a method for saving the administrative tables in a separate memory area of the nonvolatile memory when the system is turned off. However, this is possible only with a proper shutdown; if there is an unexpected power failure, the administrative data records are lost.

It is the object of the invention to reveal a method that permits the administrative data records for a memory that can be written in units of sectors and erased in units of blocks to be maintained in a high-speed volatile flag memory of the associated memory controller and to completely restore these administrative data records during a restart after a power failure.

This object is met in such a way that in the nonvolatile memory a reconstruction table is continually updated, in which the write and erase operations are recorded as an entry to such an extent that the administrative data records of the internal flag memory can be completely reconstructed in each case during a restart after a power failure.

Advantageous embodiments are specified in the subclaims.

In the nonvolatile memory one or more data blocks are reserved, into which a reconstruction table is written. This reconstruction table has a defined length of e.g., 128 sectors. In the volatile memory, administrative data records are created for the memory blocks that are being written to, said administrative data records containing among other things the logical and physical block addresses, as well as the addresses of the alternate blocks that are actively being written to. If new memory blocks are now written to, or new alternate blocks are made available, and obsolete assignments of logical to physical block addresses are dissolved, one entry is continually written into the reconstruction table in each case. The respective entry in the reconstruction table contains at least the logical block address, the physical block address of the original memory block, as well as the address of the possibly used alternate block.

If, after a power failure, a restart of the memory system now takes place, the administrative data records in the volatile flag memory are initialized empty by the program of the memory controller and the reconstruction table is then processed from the beginning and the assignments are entered into the administrative data records based on each entry in the reconstruction table. This is repeated for each entry in the reconstruction table until the end of this table has been reached. In the process it is quite possible that some assignments are overwritten multiple times since they were also updated in the course of the original processes of saving. At the end of the restart, however, the current status of the address assignments in the administrative data records is restored to the form in which it existed prior to the power failure.

In an advantageous embodiment of the reconstruction table, the same is set up in such a way that every entry in the table is exactly one sector long, even if not all bytes of the sector are filled. Since the memory is always written to in units of sectors, no additional effort is required for data preparation. Even though this leaves some memory space unused, this is of no consequence given the size of the total memory. Since all sectors, starting from the current entry in the table onward, are also erased, the next entry is written directly into the table without any additional effort.

With some types of-nonvolatile memory it is also possible to write only a segment of a sector, of e.g., 128 bytes, independently from the other segments of the sector. In these types, only such a segment of a sector is written to, and accordingly for example only one memory block is needed for the reconstruction table.

Due to the special design of the reconstruction table and storing of this table in the nonvolatile memory, the effect is that even during a reconstruction of the administrative data records, no errors will be caused if the power is lost again. This is due to the fact that during the renewed restart of the system, the reconstruction table is analyzed again in its entirety and the current state of the administrative data records is then arrived at in this manner.

Since the reconstruction table has a defined length, e.g., 128 entries, it is filled almost to the end during normal memory operation. A reorganization is started preferably after the next to last entry has been written. For this purpose, a record regarding the reorganization is written into the reconstruction table as the last entry. All address assignments as they are currently listed in the administrative data records are then erased and a defined initial state is thus created in the administrative data records, like it would also first be initialized during a system restart.

The method is improved further if a completion entry is written into the reconstruction table after a successful reorganization. This completion entry is advantageously provided with a count value, which is incremented during every reorganization.

Additionally, it is advantageous-during every reorganization to create a new reconstruction table in other memory blocks. These are taken from-the supply of erased memory blocks that are either still originally erased or that were erased by a background program. The completion entry is written into the new reconstruction table as the first entry. The blocks that have existed for the reconstruction table so far are then released and in this manner marked in such a way that they are prepared for erasing by the background program. If there is a power failure during the process of the reorganization and a new completion entry was not yet written, the reorganization is started anew during the system restart. The organization is repeatable any number of times.

If the completion entry was already written but the existing reconstruction table was not yet released, it is possible that two reorganization-tables, the previous one and the new one, are found during a restart of the system. In that case, a determination regarding which is the newer table is made based on the count value in the completion entry of the reconstruction table and the reorganization process is continued accordingly. The correct continued operation of the memory system is thus ensured in those cases as well.

During each new address assignment of physical block addresses to logical block addresses, the block pointers in the block pointer table must be changed accordingly. This block pointer table is located in the nonvolatile memory and writing of the changes would have to take place every time via the alternate block mechanism. To optimize the write operations, an intermediate pointer table is maintained in the volatile flag memory in which intermediate pointer table the changed address assignments with the logical block address and changed physical block address are recorded. This table is organized according to logical block addresses. If an address assignment is now performed, a check is first performed in this intermediate pointer table, whether the logical block address is recorded there. If this is the case the physical memory address listed there is used, otherwise the physical memory block address from the block pointer table is used. The intermediate pointer table thus indicates which entries in the block pointer table are no longer valid. With the above-described reorganization, the block pointer tables in the nonvolatile memory are also written anew and updated with the values from the intermediate pointer table. The changes of the block pointers are thus written anew into the nonvolatile memory only during the reorganization, and a great number of write operations has thus been eliminated.

If there is a power failure, the intermediate pointer table is lost. However, since every new address assignment with its logical and physical block addresses since the last reorganization has been saved as an entry in the reconstruction table, the intermediate pointer table is also reconstructed during a restart of the system.

The embodiment of the invention is described by way of example in the figures.

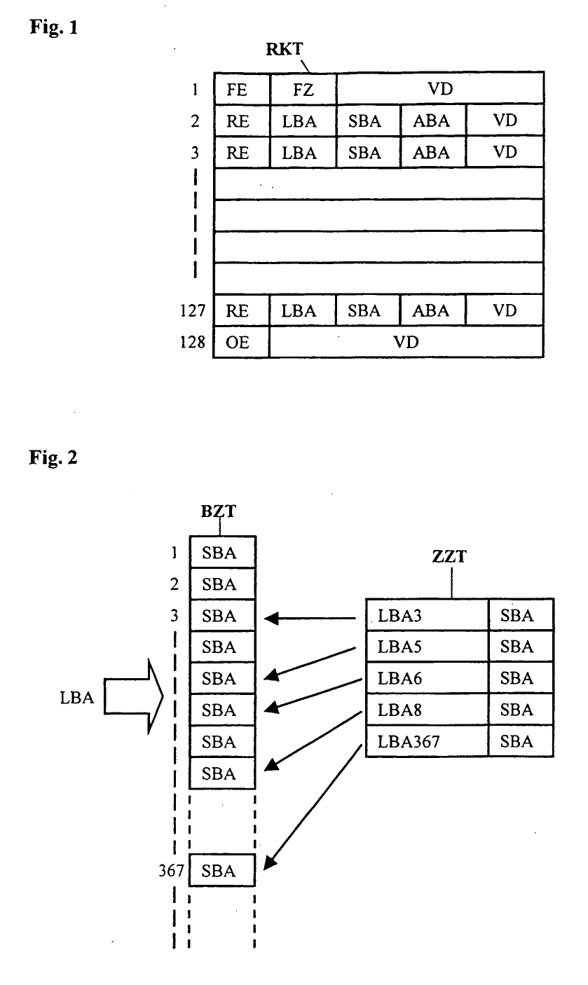

FIG. 1 shows the setup of a reconstruction table.

FIG. 2 shows the correlation between the intermediate pointer table and the block pointer table.

FIG. 1 shows the setup of the reconstruction table RKT. It consists of 128 entries in this case, each of which is one sector long. The first entry is marked as the completion entry FE and additionally contains the completion counter FZ. There is room for additional administrative data VD. Starting with the second entry, reconstruction entries RE are recorded that contain, from the memorized write operations, the entries for the logical block addresses LBA, the physical memory block addresses SBA, the utilized alternate block addresses ABA, as well as additional administrative data VD. The last entry in the reconstruction table RKT is marked as reorganization entry OE. It, too, has room for additional administrative data VD.

In FIG. 2 the block pointer table BZT is shown, which is indexed with the logical block address LBA and contains in each case the associated physical memory block address SBA. This table BZT is located in the nonvolatile memory. In the volatile flag memory, the intermediate pointer table ZZT is established, which contains in each table line an assignment of logical block addresses LBA to physical memory block addresses SBA. These are the logical block addresses LBA, the assignment of which to physical memory block addresses SBA has changed since the last reorganization. The table lines are sorted according to ascending logical block addresses LBAn and indicate the entries in the block pointer table BZT that are no longer valid and will be updated during the next reorganization.

### REFERENCE¹ NUMERALS

ABA Alternate block address
BZT Block pointer table
FE Completion entry
FZ Completion counter
LBA Logical block address
LBAn Logical block address n in the ZZT
OE Reorganization entry
RE Reconstruction entry
RKT Reconstruction table
SBA Memory block address
VD Administrative record data
ZZT Intermediate Pointer Table
   ¹Translator's Note: Approximately half of this word is missing in the German-language document on which this translation is based. It appears however, that the German word is “Bezugszeichen”, which was translated as “Reference Numerals”.

1-9. (canceled)

10. A method for restoring administrative data records of a nonvolatile memory that can be written in units of sectors and erased in units of blocks, said records being stored in a more rapidly accessible internal volatile flag memory of an assigned memory controller, characterized in that in one or more memory blocks of the nonvolatile memory a contiguous reconstruction table (RKT) is continually updated in which all write and erase operations in the nonvolatile memory are recorded as an entry to such an extent that the administrative data records of the internal flag memory of the memory controller can be completely reconstructed in each case during a restart after a power failure, and that when a predefined fill level of the reconstruction table (RKT) is reached, a reorganization is started in each case to create a defined initial state of the administrative data records in the flag memory and in the reconstruction table (RKT), and that this start of the reorganization is recorded as the last entry (OE) in the reconstruction table.

11. A method according to claim 10, characterized in that every entry in the reconstruction table (RKT) is one sector or one sector segment long.

12. A method according to claim 10, characterized in that the reconstruction of the administrative data records of the flag memory is repeated if another power failure has occurred during the reconstruction of the data records.

13. A method according to claim 10, characterized in that every time the reorganization was successful, a completion entry (FE) takes place in the reconstruction table, said completion entry containing a counter (FZ), which is incremented with every completion entry.

14. A method according to claim 13, characterized in that for the renewed creation of the reconstruction table (RKT) after a successful reorganization, the previously used memory blocks are released for erasing in a background program and a still erased blocks are initialized accordingly.

15. A method according to claim 14, characterized in that the first entry in a reconstruction table (RKT) is a completion entry (FE).

16. A method according to claim 10, characterized in that, as a portion of the administrative data records, a table (ZZT) is maintained in the flag memory for any invalid block pointers that are contained in a block pointer table (BZT) in the nonvolatile memory.

17. A method according to claim 12, characterized in that during the reorganization the block pointer table (BZT) is updated in each case with aid of the table (ZZT) for invalid block pointers.
